(19) United States
(12) Patent Application Publication
(10) Pub. No.: US 2006/0075212 A1
(43) Pub. Date: Apr. 6, 2006

(54) Programmable logic analyzer data analyzing method

(75) Inventors: Chiu-Hao Cheng, Miaoli Hsien (TW); Ming-Gwo Cheng, Taichung Hsien (TW); Chun-Feng Tzu, Miaoli Hsien (TW)

Correspondence Address: BACON & THOMAS, PLLC, 625 SLATERS LANE, FOURTH FLOOR, ALEXANDRIA, VA, 22314, US

(73) Assignee: Zeroplus Technology Co., Ltd., Chungho City, Taipei Hsien (TW)

(21) Appl. No.: 10/541,190

(22) PCT Filed: Dec. 31, 2002
(86) PCT No.: PCT/US02/38991

§ 371 Date: Jun. 30, 2005

(51) Int. Cl. G06F 9/44

(52) U.S. Cl. 712/227

(57) ABSTRACT

A programmable logic analyzer data analyzing method includes the step of controlling a control circuit to fetch waveform data from the test sample and to store fetched waveform data in a memory, the step of controlling the control circuit to transmit the waveform data from the memory to a computer through a transmission interface when the memory space of the memory used up (fully occupied), the step of driving the computer to write the received waveform data in a buffer thereof, and the step of running a test sample test signal auxiliary analyzing procedure for enabling the user to use the displayed on the display screen of the computer for making debugging data analysis, comparison data analysis and search data analysis, to store the analyzed data in the form of a file, or to print out the analyzed data through a printer.

### BACKGROUND OF THE INVENTION

1. Field of the Invention

The present invention relates to logic analyzers and, more specifically, to a programmable logic analyzer data analyzing method, which enables the waveform data of the test sample to be fetched by a logic analyzer and then transmitted to the display screen of a computer for display, so that the user can use the displayed data to make debugging data analysis, comparison data analysis and search data analysis, to store the analyzed data in the form of a file, or to print out the analyzed data through a printer.

2. Description of the Related Art

A regular logic analyzer can simply fetch data from the test digital circuit (for example, an integrated circuit) for display on a display screen, and for further visual analysis by a man. When designing a logic analyzer, the designer may consider the factors of (1) depth of memory, (2) speed of data fetching, (3) capability of triggering, and (4) stability (anti-noise capability). According to conventional techniques, it is difficult to achieve a breakthrough. Following fast development of high technology, the limited functions of conventional logic analyzers cannot meet the requirements of programming engineers. Programming engineers require high performance analyzer to help developing advanced products. Current logic analyzer can simply test specific items but not all products of same category. For example, a logic analyzer for testing a USB communication interface cannot be used to test other communication interface such as RS0232. Due to this drawback, a programming engineer may have to prepare various logic analyzers for different test purposes.

Therefore, it is desirable to provide a programmable logic analyzer data analyzing method that provides a complete series of functions including testing, debugging, and analyzing functions.

### SUMMARY OF THE INVENTION

The present invention has been accomplished under the circumstances in view. According to one embodiment of the present invention, the programmable logic analyzer data analyzing method comprises the step of controlling a control circuit to fetch waveform data from the test sample and to store fetched waveform data in a memory, the step of controlling the control circuit to transmit the waveform data from the memory to a computer through a transmission interface when the memory space of the memory used up (fully occupied), the step of driving the computer to write the received waveform data in a buffer thereof, and the step of running a test sample test signal auxiliary analyzing procedure for enabling the user to use the displayed on the display screen of the computer for making debugging data analysis, comparison data analysis and search data analysis, to store the analyzed data in the form of a file, or to print out the analyzed data through a printer. According to another embodiment of the present invention, the programmable logic analyzer data analyzing method comprises the step of controlling a control circuit to fetch waveform data from the test sample and to store fetched waveform data in a memory, the step of writing the waveform data in a buffer when the memory space of the memory used up (fully occupied), the step of driving the control circuit to transmit the waveform data from the buffer to a display, and the step of running a test sample test signal auxiliary analyzing procedure for enabling the user to make data analyses based on the data received from the memory by the computer and displayed on a display screen of the computer.

### BRIEF DESCRIPTION OF THE DRAWINGS

FIG. 1A is a circuit block diagram of a logic analyzer according to the present invention.

FIG. 1B is a circuit block diagram of an alternate form of the logic analyzer according to the present invention.

FIG. 2 is a flow chart of the present invention.

FIG. 3 is a flow chart of the test sample waveform quality analysis according to the present invention.

FIG. 3A is a flow chart of the output logic analysis of the waveform quality analysis according to the present invention.

FIG. 3B is a flow chart of the waveform bandwidth analysis of the waveform quality analysis according to the present invention.

FIG. 3C is a flow chart of the comparison data analysis of the waveform quality analysis according to the present invention.

FIG. 3D is a flow chart of the input forbidding analysis of the waveform quality analysis according to the present invention.

FIG. 3E is a flow chart of the search data analysis of the waveform quality analysis according to the present invention.

FIG. 4 is a flow chart of the communication protocol analysis according to the present invention.

FIG. 4A is a flow chart of the debugging data analysis of the communication protocol analysis according to the present invention.

FIG. 4B is a flow chart of the search data analysis of the communication protocol analysis according to the present invention.

FIG. 5 is a flow chart of the memory data analysis according to the present invention.

FIG. 5A is a flow chart of the read write data analysis of the memory data analysis according to the present invention.

FIG. 5B is a flow chart of the comparison data analysis of the memory data analysis according to the present invention.

FIG. 5C is a flow chart of the search data analysis of the memory data analysis according to the present invention.

FIG. 6A is a circuit block diagram of another alternate form of the logic analyzer according to the present invention.

FIG. 6B is a circuit block diagram of still another alternate form of the present invention.

FIG. 7 is a schematic drawing showing the display of the communication protocol display window according to the present invention.

FIG. 8 is a schematic drawing showing the display of the memory data display window according to the present invention.

FIG. 9 is a schematic drawing showing the display of the logic analyzer control display window according to the present invention.

### DETAILED DESCRIPTION OF THE PREFERRED EMBODIMENT

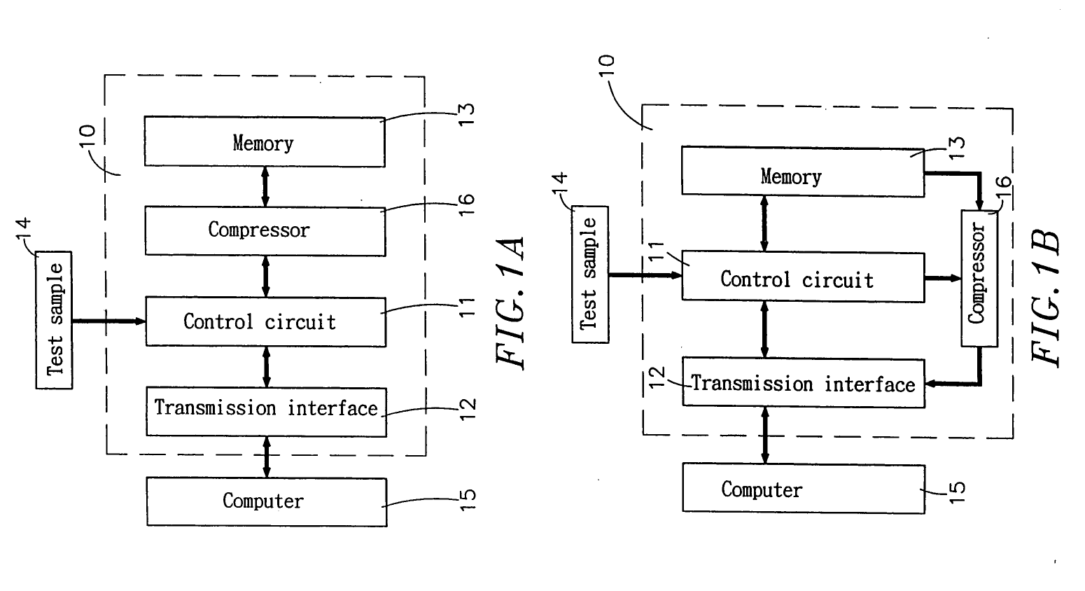

Referring to FIG. 1A, a logic analyzer 10 in accordance with the present invention comprises a control circuit 11, a transmission interface 12, a memory 13, and a compressor 16. The control circuit 11 is connected to the test sample 14 through an implement (not shown). The transmission interface 12 is connected to a host computer 15. The control circuit 11 reads in test data from the test sample 14, and then sends obtained test data to the compressor 16 for compression, for enabling compressed data to be further stored in the memory 13. When the memory space of the memory 13 used up (fully occupied by storage data), the control circuit 11 transmits compressed storage data from the memory 13 to the computer 15 through the transmission interface 12 for decompression by the computer 15 and for display on the display screen of the computer 15 after decompression.

FIG. 1B shows an alternate form of the logic analyzer 10. According to this alternate form, the control circuit 11 obtains test data from the test sample 14, and then directly stores obtained test data in the memory 13. When the memory space of the memory 13 used up (fully occupied by storage data), the control circuit 11 retrieves storage test data from the memory 13 and sends retrieved storage test data to the compressor 16 for compression, and then drives the transmission interface 12 to transmit compressed test data from the compressor 16 to the computer 15 for decompression by the computer 15 and for display on the display screen of the computer 15 after decompression.

With reference to FIGS. 1A and 1B again, when the logic analyzer 10 received a test sample data sheet inputted by the user or when the user selected the code number of the test sample from the database, the control circuit 11 of the logic analyzer 10 fetches waveform data from the test sample 14, and then stores fetched waveform data in the memory 13, and then drives the transmission interface 12 to transmit storage waveform data from the memory 13 to the computer 15 when the memory space of the memory 13 used up (fully occupied by storage data). Upon receipt of waveform data from the data analyzer 10, the computer 15 fills the data in a buffer, and then transmits the data from the buffer to the display screen for display. Thereafter, a test sample (digital circuit) test signal auxiliary analyzing procedure 100 is performed. This test sample test signal auxiliary analyzing procedure 100 includes waveform quality analysis 20, communication protocol analysis 30, and memory data analysis 40. Thus, the user can use the data displayed on the display screen of the computer 15 to run debugging data analysis, comparison data analysis and search data analysis, or store analyzed data in the form of a file or print out analyzed data through a printer.

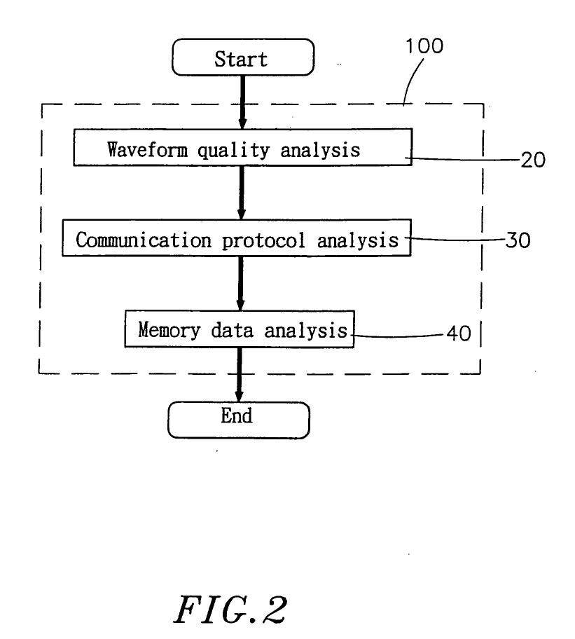

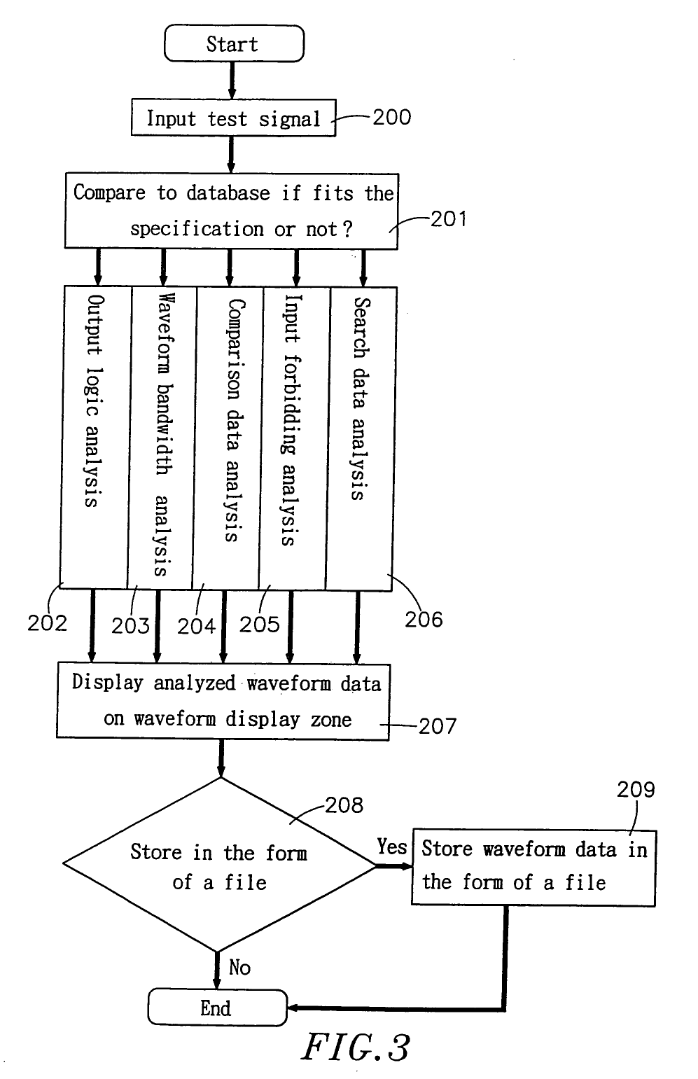

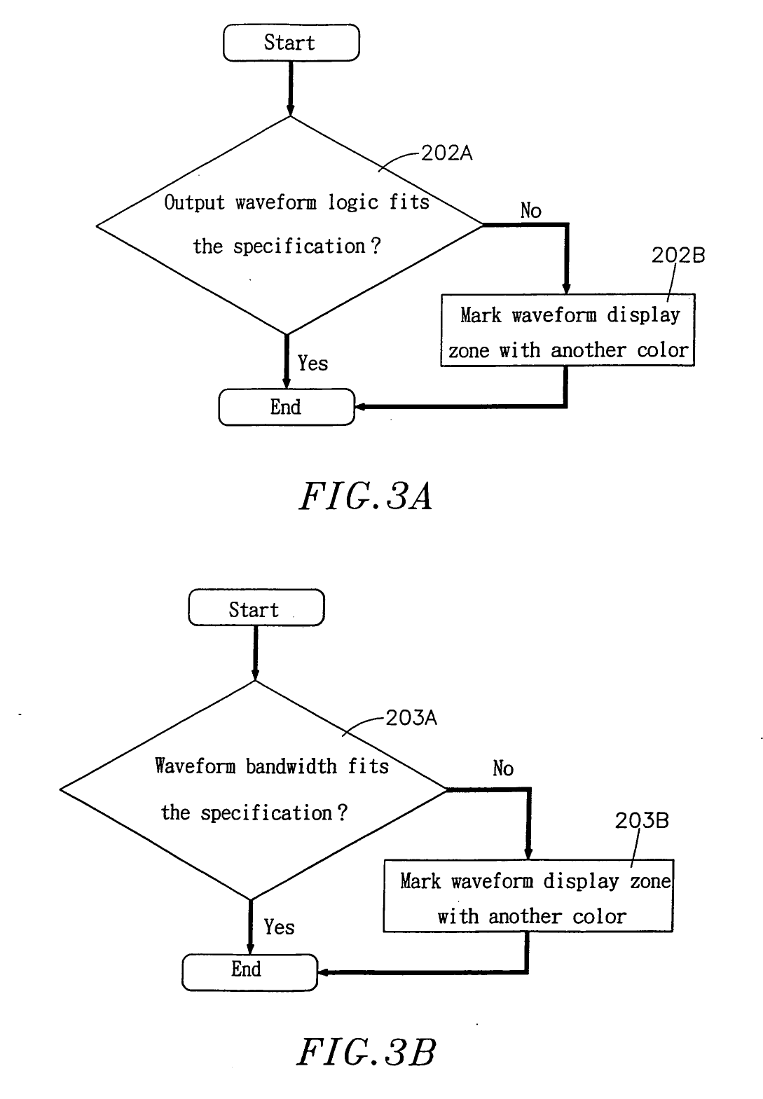

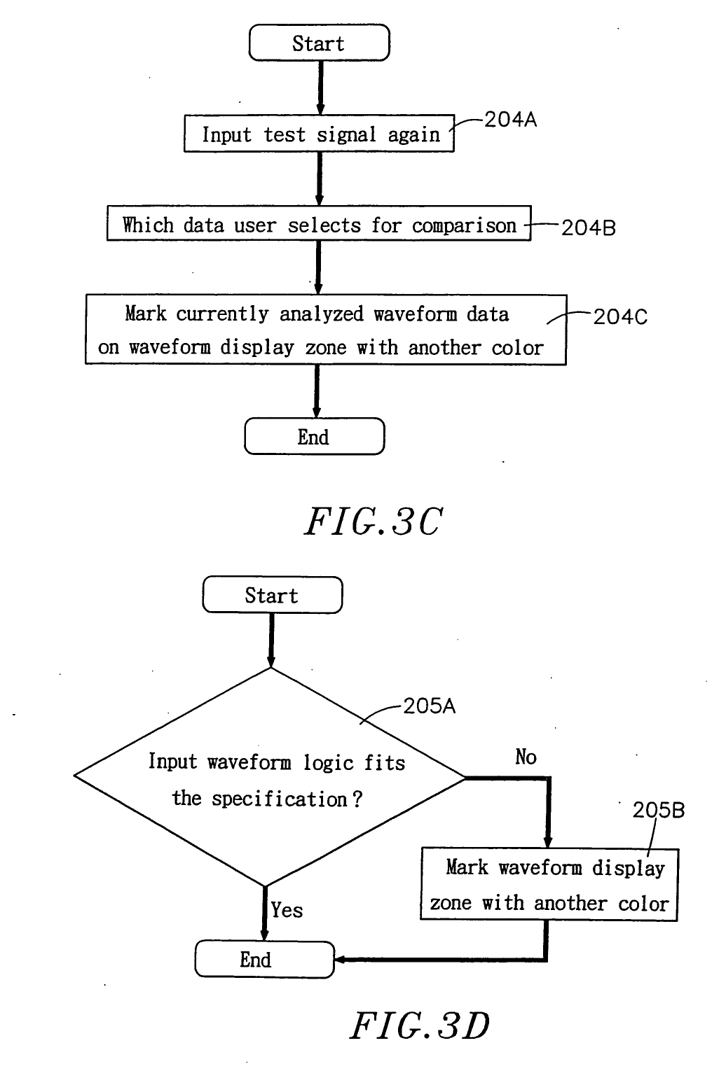

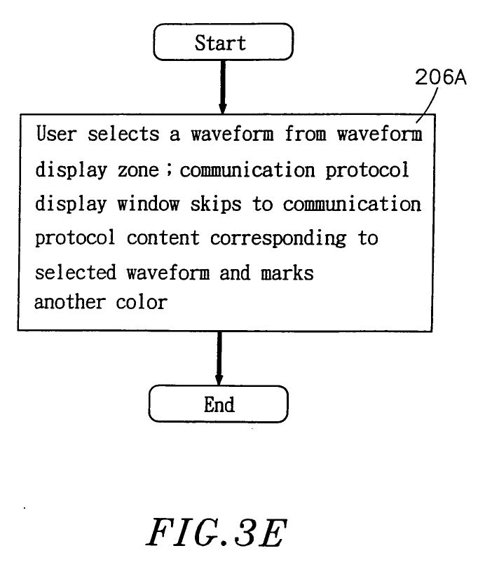

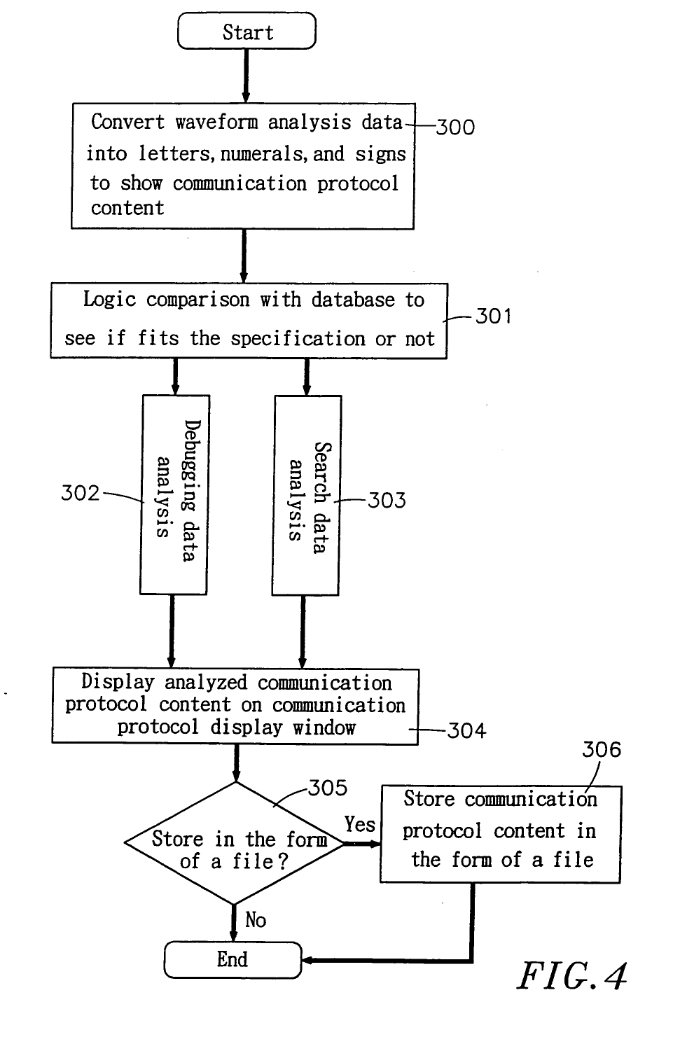

Referring to FIG. 3 and FIG. 2 again, the waveform quality analysis 20 of the test sample test signal auxiliary analyzing procedure 100 works subject to the steps bellows:
(200) Input test signal;
(201) Make a logic comparison with the data base to see if the inputted test signal meets feature specification;
(202) Output logic analysis; at this time, proceed to step (202A) to determine if output waveform logic fits the specification or not? And then terminate the analysis action if positive (see FIG. 3A), or proceed to step (202B) to mark the waveform display zone with another color and then terminate the analysis action if negative (see FIG. 3A and also FIG. 9);
(203) Waveform bandwidth analysis; at this time, proceed to step (203A) to determine if the waveform bandwidth fits the specification or not? And then terminate the analysis action if positive (see FIG. 3B), or proceed to step (203B) to mark the waveform display zone with another color and then terminate the analysis action if negative (see FIG. 3B and also FIG. 9);
(204) Comparison data analysis; at this time, proceed to step (204A) to input test signal again, and then to step (204B) to let the user select the data for comparison, and then to step (204C) to mark the currently analyzed waveform data in the waveform display zone with another color, and then terminate the analysis action (see FIG. 3C and FIG. 9);
(205) Input forbidding analysis; at this time, proceed to step (205A) to determine if input waveform logic fits the specification or not? And then terminate the analysis action if positive, or proceed to step (205B) to mark the waveform display zone with another color if negative (see FIG. 3D and also FIG. 9);
(206) Search data analysis; at this time, proceed to step (206A) where the user selects a waveform from the waveform display zone (see FIG. 9), the communication protocol display window (see FIG. 7) skips to the communication protocol content corresponding to the selected waveform, and the analysis action is terminated after the marking of another color (see FIG. 3E);
(207) Display analyzed waveform data on the waveform display zone (see FIG. 9);
(208) Store the waveform data in the form of a file or not? And then proceed to step (209) if positive, or terminate the analysis action if negative;
(209) Store the waveform data in the form of a file, and then terminate the analysis action.

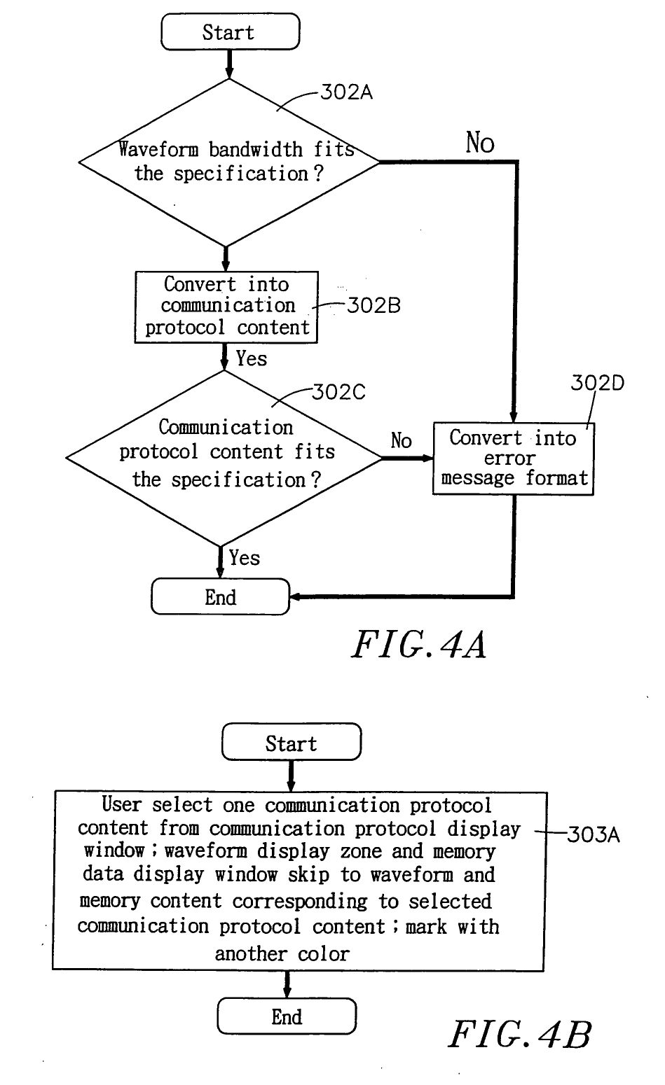

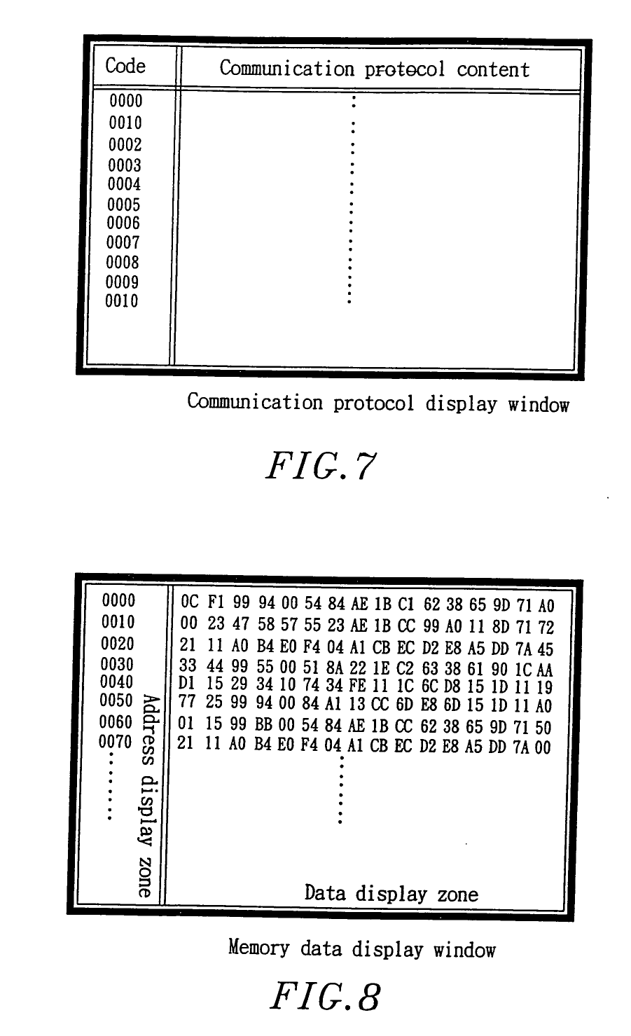

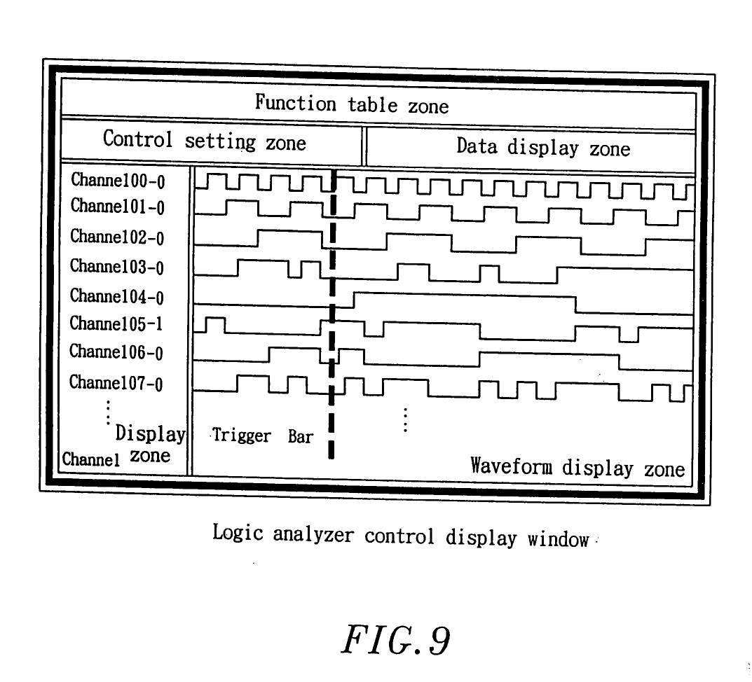

With reference to FIGS. 2 and 4, the communication protocol analysis 30 of the test sample test signal auxiliary analyzing procedure 100 works subject to the steps bellows:
(300) Convert waveform analysis data into letters, numerals, or signs to show the communication protocol content;
(301) Make a logic comparison with the database to see if it fits the specification or not;
(302) Debugging data analysis; at this time, proceed to step (302A) to determine if the waveform bandwidth fits the specification or not? And then proceed to step (302B) if positive, or to step (302D) if negative; when entered step (302B), it converts the data into communication protocol content, and then proceeds to step (302C) to terminate of the communication protocol contents fits the specification or not? And then terminate the analysis action if positive, or proceed to step (302D) to convert the data into error message and then terminate the analysis action if negative (see FIG. 4A);
(303) Search data analysis; at this time (see also FIG. 4B), proceed to step (303A) where the user selects a communication protocol content from the communication protocol display zone (See FIG. 7), the waveform display zone (See FIG. 9) and the memory data display window (see FIG. 8) skip to the waveform and the memory content corresponding to the selected communication protocol content, and the analysis action is terminated after the marking of another color;
(304) Display analyzed communication protocol content on the display zone of the communication protocol display window (See FIG. 7), and then proceed to step (305);
(305) Store the displayed communication protocol content in the form of a file or not? Proceed to step (306) if positive, or terminate the analysis action if negative;
(306) Store the communication protocol content in the form of a file, and terminate the analysis action.

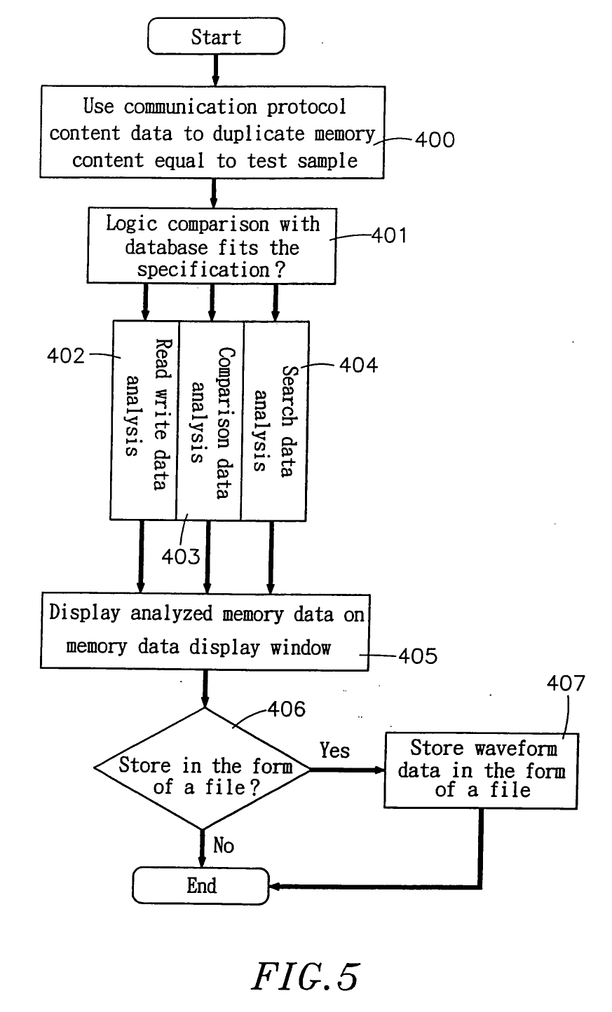

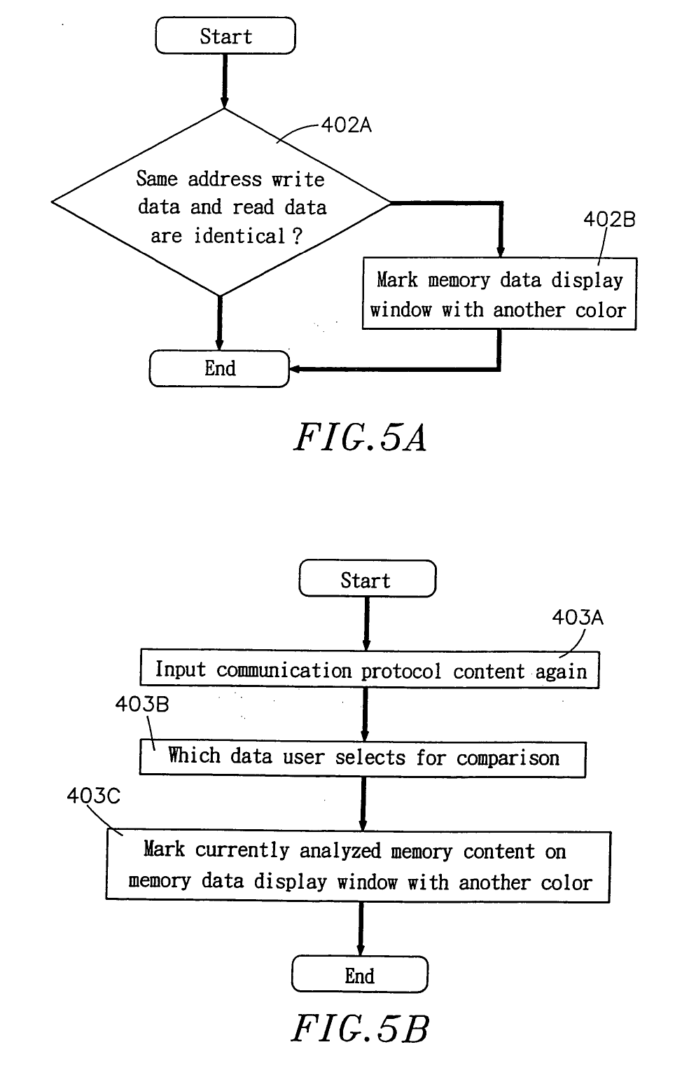

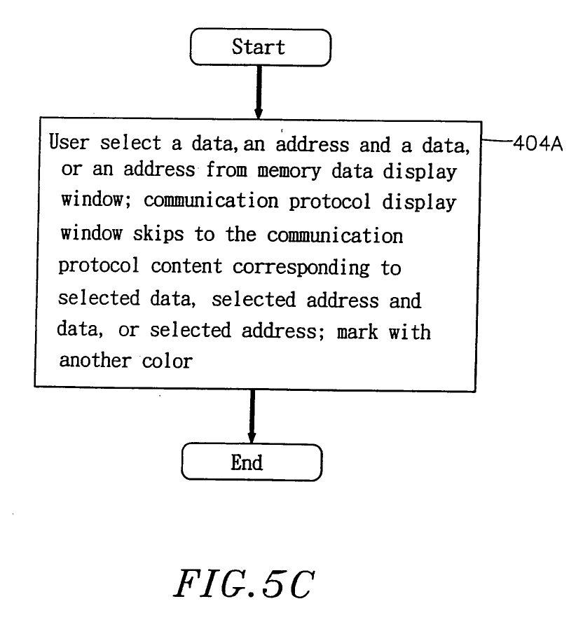

With reference to FIGS. 2 and 5, the memory data analysis 40 of the test sample test signal auxiliary analyzing procedure 100 works subject to the steps bellows:
(400) Use the data of the communication protocol content to duplicate one copy of memory content same as the test sample;
(401) Make a logical comparison with the database to see if it fits the specification or not;
(402) Read write data analysis; at this time (see FIG. 5A), proceed to step (402A) to determine if same address read data and write data are identical or not? And then terminate the analysis action if positive, or proceed to step (402B) to mark the memory data display window with another color and then to terminate the analysis action if negative;
(403) Comparison data analysis; at this time (See FIG. 5B), proceed to step (403A) to input the communication protocol content again, and then proceed to step (403B) to let the user select which data to be compared, and then proceed to step (403C) to mark the currently analyzed memory content on the memory data display window with another color (see FIG. 8), and then terminate the analysis action;
(404) Search data analysis; at this time (see FIG. 5C), proceed to step (404A) where the user selects a data, an address and a data, or an address from the memory data display window (See FIG. 8), the communication protocol display window (see FIG. 7) skips to the communication protocol content corresponding to the selected data, selected address and data, or selected address, and the analysis action is terminated after the marking of another color;
(405) Display the analyzed memory data on the memory data display window (see FIG. 8);
(406) Store the analyzed memory data in the form of a file? And then proceed to step (407) when positive, or terminate the analysis action when negative;
(407) Store the analyzed memory data in the form of a file, and then terminate the analysis action.

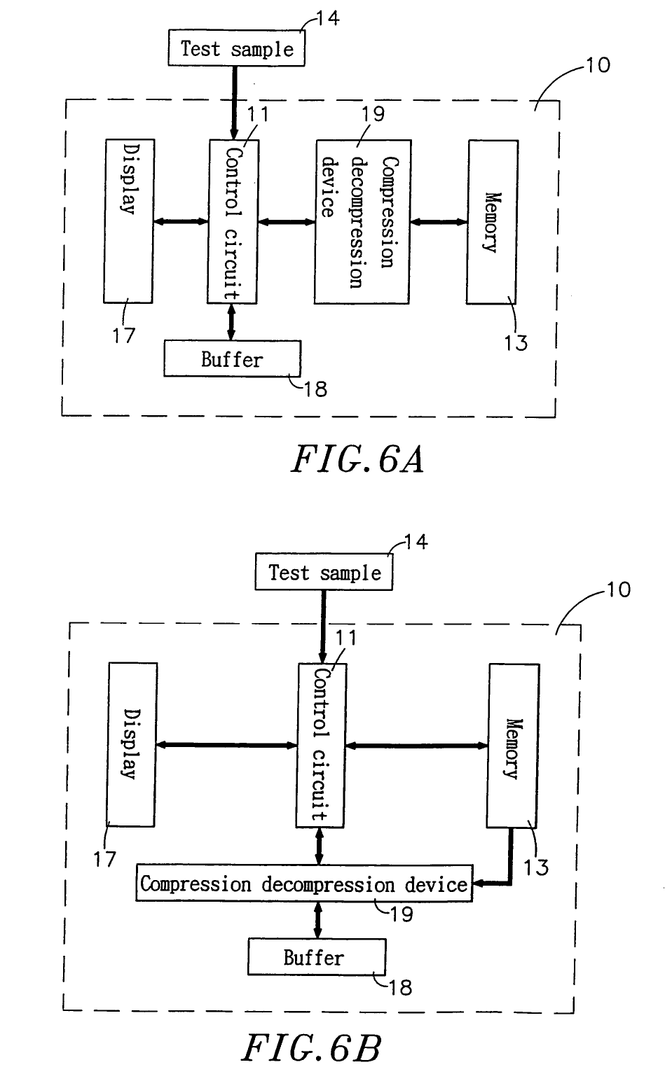

FIG. 6A shows another alternate form of the logic analyzer 10. According to this design, the logic analyzer 10 is comprised of a control circuit 11, a memory 13, a display 17, and a buffer 18. The control circuit 11 is connected to the test sample 14 through an implement. During operation, the control circuit 11 reads in test data from the test sample 14, and then stores obtained test data in the memory 13. When the memory space of the memory 13 used up (fully occupied by storage data), the control circuit 11 transmits storage data from the memory 13 to the buffer 18, and then transmits the data from the buffer 18 to the display 17 for display. Further, when the logic analyzer 10 received a test sample data sheet inputted by the user or a test sample code number selected from the database of the logic analyzer 10 by the user, the control circuit 11 fetches the waveform data from the test sample 14, and then stores the fetched data in the memory 13, and then transmits the data from the memory 13 to the buffer 18 when the memory space of the memory used up (fully occupied), and then transmits the data from the buffer 18 to the display 17 for display, and then runs the waveform quality analysis 20, communication protocol analysis 30 and memory data analysis 40 of the test sample test signal auxiliary analyzing procedure 100 (see FIG. 2). Thus, the user can use the data displayed on the display 17 for making debugging data analysis, comparison data analysis, search data analysis, etc., store the analyzed data in the form of a file, or print out the analyzed data through a printer. This logic analyzer 10 further comprises a compression decompression device 19, which compresses data obtained by the control circuit 11 from the test sample 14 before storing in the memory 13, and decompresses the storage data for display on the display 17 when the memory space of the memory 13 used up (fully occupied).

FIG. 6B shows still another alternate form of the logic analyzer 10. According to this design, the control circuit 11 directly stores the fetched test data from the test sample 14 in the memory 13, and then drives the compression decompression device 19 to compress the storage data when the memory space of the memory 13 used up (fully occupied), and then stores the compressed data in the buffer 18, and then drives the compression decompression device 19 to decompress the compressed data, and then transmits the decompressed data to the display 17 for display.

According to the embodiments shown in FIGS. 6A and 6B, the capacity of the buffer 18 of the computer 15 or the capacity of the buffer 18 of the logic analyzer 10 varies with the amount of the internal data of the test sample 14.

A prototype of programmable logic analyzer data analyzing method has been constructed with the features of the annexed drawings of FIGS. 1˜9. The programmable logic analyzer data analyzing method functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1-28. (canceled)

29. A method of analyzing waveform data of a test sample using a programmable logic analyzer, the programmable logic and analyzer comprising a control circuit for fetching the waveform data from the test sample, a memory for storing the fetched waveform data, wherein the programmable logic analyzer is connected to a computer so that the stored waveform data is transmitted to the computer for running tests on the waveform data received from the programmable logic analyzer, the method comprising:
storing the waveform data of the test sample into the memory;
determining whether the stored waveform data of the test sample meets with a predetermined feature specification;
transmitting the waveform data to a computer, wherein the computer performs a waveform analysis of the waveform data of the test sample; and
displaying a result of the waveform analysis on a display.

30. The method of claim 29, wherein the step of performing waveform analysis comprises a debugging data analysis.

31. The method of claim 29, wherein the step of performing waveform analysis comprises a waveform data quality analysis.

32. The method of claim 29, wherein the step of performing waveform analysis comprises a comparison data quality analysis.

33. The method of claim 29, wherein the step of performing waveform analysis comprises a search data quality analysis.

34. The method of claim 29, further comprising a step of compressing the fetched waveform data of the test sample prior to storing in the memory.

35. The method of claim 34, further comprising a step of decompressing the compressed waveform data of the test sample prior to display on the display.

36. The method of claim 29, further comprising a step of printing the results displayed on the display.

37. The method of claim 29, further comprising a step of saving the result in a file.

38. The method of claim 29, wherein if the waveform data do not meet with the predetermined specification, waveform display zone is marked with a different color.

39. A programmable logic analyzer connected to a computer, comprising a control circuit, for fetching waveform data from a test sample; and
a memory, for storing the fetched waveform data;
wherein the computer is adopted for performing a waveform analysis of the waveform data of the test sample stored in the memory when the waveform data of the test sample meets with a predetermined specification and displaying a result on a display.

40. The programmable logic analyzer of claim 39, wherein the waveform analysis comprises a debugging data analysis.

41. The programmable logic analyzer of claim 39, wherein the waveform analysis comprises a waveform data quality analysis.

42. The programmable logic analyzer of claim 39, wherein the waveform analysis comprises a comparison data analysis.

43. The programmable logic analyzer of claim 39, wherein the waveform analysis comprises a search data quality analysis.

44. The programmable logic analyzer of claim 39, further comprising a compressor connected to the memory for compressing the fetched waveform data of the test sample prior to storing in the memory.

45. The programmable logic analyzer of claim 44, further comprising a decompressor connected to the memory for decompressing the compressed waveform data of the test sample prior to display on the display.

46. The programmable logic analyzer of claim 39, further comprising a printer connected to the computer for printing the result display on the display.

47. The programmable logic analyzer of claim 39, the result is saved in a file.

48. The method of claim 39, wherein if the stored waveform data of the test sample do not meet the predetermined feature specification, waveform display zone is marked with a different color.
